(19) United States
(12) Patent Application Publication
(10) Pub. No.: US 2025/0307828 A1
(43) Pub. Date: Oct. 2, 2025

(54) SOFTWARE APPLICATION FOR PERFORMING CERTIFICATION TESTING OF PAYMENT TERMINALS

(71) Applicant: Discover Financial Services, Riverwoods, IL (US)

(72) Inventor: Krishna Mohan, Buffalo Grove, IL (US)

(21) Appl. No.: 18/670,330

(22) Filed: May 21, 2024

Related U.S. Application Data
(60) Provisional application No. 63/573,356, filed on Apr. 2, 2024.

(51) Int. Cl. G06Q 20/40; G06Q 20/34

(52) U.S. Cl. CPC G06Q 20/409; G06Q 20/351

(57) ABSTRACT

A client device is configured to (i) load a set of virtual test card profiles, (ii) present a graphical user interface (GUI) that enables selection of an operating mode for use in testing a payment terminal and a virtual test card profile for use in testing the payment terminal, (iii) receive a user selection of an operating mode for use in testing the payment terminal and a user selection, from the set of virtual test card profiles, of a virtual test card profile for use in testing the payment terminal, and (iv) based on the user selections, selectively operate in either (a) a first operating mode in which the client device emulates a physical payment card in accordance with the virtual test card profile or (b) a second operating mode in which the client device configures a configurable payment card to operate in accordance with the virtual test card profile.

### CROSS-REFERENCE TO RELATED APPLICATIONS

This application claims priority under 35 U.S.C. § 119 (e) to U.S. Provisional Application No. 63/573,356, filed on Apr. 2, 2024, and titled “SOFTWARE APPLICATION FOR PERFORMING CERTIFICATION TESTING OF PAYMENT TERMINALS,” which is incorporated by reference herein in its entirety.

### BACKGROUND

Payment cards (e.g., debit cards, credit cards, etc.) are a common means of payment for financial transactions, in lieu of cash or checks. Payment cards are more transportable than cash or checks, enable automated tracking of financial activity, and may provide some layer of consumer protection to a cardholder of the payment card. Processing transactions that are made by consumers using payment cards is typically a two-stage process.

During one possible implementation of the first stage, the merchant's payment system sends an authorization request for a transaction to a computing platform of the merchant's acquiring financial institution (often referred to as the “acquirer bank”) or an associated processor, which in turn routs the authorization request to a computing platform of the financial institution that issued the payment (often referred to as the “issuing bank”) over a payment network. After receiving the authorization request, the issuing bank's computing platform renders a decision as to whether the transaction should be approved or denied and generates an authorization response memorializing that decision, which gets routed back to the acquirer bank's computing platform (or an associated processor) and then back to the merchant's payment system.

Then, during one possible implementation of the second stage, the merchant's payment system sends a settlement request for the authorized transaction (and perhaps other authorized transactions) to the acquirer bank's computing platform or an associated payment processor, which in turn routes the settlement request to the issuing bank's computing platform over a payment network. After the issuing bank receives and approves the settlement request, the funds for the transaction are transferred from the issuing bank's computing platform to the acquirer bank's computing platform through the payment network, the acquirer bank deposits the proceeds from the transaction into a bank account of the merchant, and the issuer bank charges the cardholder for the transaction.

The processing of a payment card could take various other forms as well.

### SUMMARY

Disclosed herein is new technology for certification testing of payment terminals.

In one aspect, the disclosed technology may take the form of a method to be carried out by a client device the involves (i) loading a set of virtual test card profiles, (ii) presenting a graphical user interface (GUI) of the software application that enables selection of (a) an operating mode for use in testing a given payment terminal and (b) a virtual test card profile for use in testing the given payment terminal, (iii) receiving, via the GUI of the software application, (i) a first user selection of a given operating mode for use in testing the given payment terminal and (ii) a second user selection, from the loaded set of virtual test card profiles, of a given virtual test card profile for use in testing the given payment terminal, and (iv) based on the first and second user selections, selectively operating in either: (a) a first operating mode in which the client device emulates a physical payment card in accordance with the given virtual test card profile, or (b) a second operating mode in which the client device configures a configurable payment card to operate in accordance with the given virtual test card profile.

The foregoing method may further involve additional functionality. For example, the method may additionally involve presenting, via the GUI of the client device, one or both of (i) test data logged by the client device or (ii) test data retrieved from the configurable payment card. As another example, the method may additionally involve transmitting, to a remote computing system, one or both of (i) test data logged by the client device or (ii) test data retrieved from the configurable payment card. As yet another example, the method may additionally involve determining an optimal location for positioning a configurable payment card relative to the client device when selectively operating in the second operating mode.

The functionality for selectively operating in the first operating mode in which the client device emulates the physical payment card in accordance with the given virtual test card profile may take various forms, and in some examples, this functionality may involve engaging in wireless communications with the given payment terminal related to a test transaction between the client device and the given payment terminal. In some such examples, the wireless communications are sent over a near field communications (NFC) link between the client device and the given payment terminal. In some other examples, the functionality for selectively operating in the first operating mode may involve the client device logging test data related to a test transaction between the client device and the given payment terminal.

The functionality for selectively operating in the second operating mode in which the client device configures the configurable payment card to operate in accordance with the given virtual test card profile may take various forms, and in some examples, this functionality may involve wirelessly transferring at least a portion of the given virtual test card profile to the configurable payment card. In some such examples, the portion of the given virtual test card profile is wirelessly transferred over a near field communications (NFC) link between the client device and the configurable payment card. In some other examples, the functionality for selectively operating in the second operating mode may involve the client device wirelessly retrieving, from the configurable payment card, test data related to a test transaction between the configurable payment card and the given payment terminal.

Still further, the GUI of the software application may take various forms. For example, the GUI of the software application may include (i) a respective selectable GUI element for each of the first operating mode and the second operating mode, and (ii) a respective selectable GUI element for each virtual test card profile in the set of virtual test card profiles.

In another aspect, disclosed herein is a client device that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium that is provisioned with program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 is a flowchart that shows an example process for authorizing an example transaction between a cardholder and a merchant.

FIG. 2 depicts one illustrative example of a computing environment in which the disclosed certification testing application may be utilized.

FIG. 3A is a flow diagram that illustrates example functionality that may be carried out by a client device installed with the disclosed certification testing application.

FIG. 3B is a flow diagram that illustrates example functionality that may be carried out by a client device installed with the disclosed certification testing application while operating in a card emulation mode.

FIG. 3C is a flow diagram that illustrates example functionality that may be carried out by a client device installed with the disclosed certification testing application while operating in a physical card mode.

FIG. 4A illustrates an example first GUI view comprising a selector input that enables a user of a client device installed with the disclosed certification testing application to select between a card emulation mode or a physical card mode selection via an input to the client device installed with the certification testing application.

FIG. 4B illustrates an example second GUI view comprising a visual representation of a selected virtual test card profile along with a textual indication that a client device installed with the disclosed certification testing application is emulating a contactless payment card having the card information included in a given virtual test card profile.

FIG. 4C illustrates an example third GUI view comprising a view that may be presented by a client device installed with the disclosed certification testing application while performing a calibration process.

FIG. 4D illustrates an example fourth GUI view comprising user instructions for positioning the given configurable payment card relative to a client device installed with the disclosed certification testing application and a visual representation of a selected virtual test card profile.

FIG. 5 is a simplified block diagram illustrating some structural components that may be included in an example computing platform that may be configured to perform some or all of the server-side functions disclosed herein.

FIG. 6 is a simplified block diagram illustrating some structural components that may be included in an example client device that may be configured to perform some or all of the client-side functions disclosed herein.

FIG. 7A is a simplified block diagram illustrating some structural components that may be included in an example payment card that may be configured to perform some or all of the payment card functions disclosed herein.

FIG. 7B depicts a top view of an example payment card that may be configured to perform some or all of the configurable payment card functions disclosed herein.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

As noted above, payment cards (e.g., debit cards, credit cards, etc.) are a common means of payment for financial transactions, in lieu of cash or checks For example, when making a purchase at a merchant's site, a consumer may present a payment card for reading by the merchant's on-site payment system, which may be carried out via either a contact-based interaction between the payment card and the merchant system (e.g., swiping a payment card in a device, inserting a payment card into a device, etc.), a contactless interaction between the payment card and the merchant system (e.g., tapping a physical card on a device, presenting a physical card proximate to a device, etc.), among various other forms.

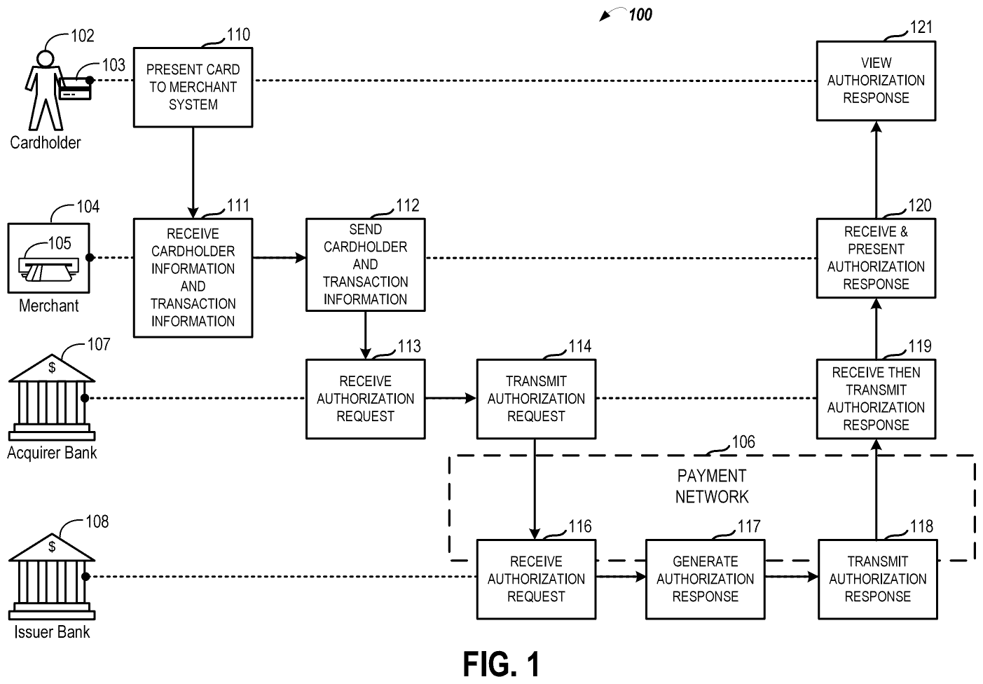

The reading of the payment card by the merchant system is just the beginning of a multi-stage process for processing such a transaction between the cardholder and the merchant, which involves various different computing systems. To illustrate, FIG. 1 is a flowchart 100 that shows an example process for authorizing an example transaction between a cardholder and a merchant, which may involve a cardholder 102 of a payment card 103, a merchant 104 that operates an on-site payment system 105 (which may be referred to herein as a “merchant system”), an acquirer bank 107 that operates a computing platform, and an issuer bank 108 that operates a computing platform.

The cardholder 102 may be any individual who has been issued a payment card 103. The payment card 103 may be associated a payment account used by the cardholder 102. While the person who is physically presenting the payment card 103 may be the cardholder 102, it is also contemplated that the cardholder 102 may not be the person who is physically presenting the payment card 103. Rather, in some examples, the cardholder 102 may be another person or a non-human entity, such as an organization.

A cardholder 102 may utilize the payment card 103 to pay for the example transaction with the merchant 104, which may be any entity (e.g., an organization, an individual, etc.) that offers goods and/or services and operates an on-site payment system that allows cardholders to pay for transactions using payment cards, which may take the form of a payment terminal comprising card reader (sometimes referred to as a point-of-sale (POS) terminal, a payment acceptance terminal, or a cash dispensing terminal) and perhaps also a computing system that interacts with such a payment terminal.

As shown, the example authorization process begins at block 110, when the cardholder 102 presents the payment card 103 for reading by the merchant system 105.

At block 111, the merchant system 105 engages in a contact-based or contactless exchange of messages with the payment card 103 and thereby receives cardholder information (e.g., cardholder account information, etc.) associated with the payment card 103. Additionally, either before or after receiving the cardholder information, the merchant system 105 also receives information associated with the example transaction between the cardholder 102 and the merchant 104. Such transaction information may be received in various manners, including through a user interface of the merchant system 105 (e.g., user input entered by a representative of the merchant 104) or from a scanner-type interface of the merchant system 105 that is configured to scan a code on a product, among other possibilities. Receipt of the cardholder information and/or the transaction information, by the merchant system 105, may take various other forms as well.

At block 112, the merchant system 105 sends the cardholder and transaction information to the computing platform of the acquirer bank 107 over a network-based communication path. While illustrated as a direct communication between the merchant system 105 and the acquirer bank 107, the flow of information between the merchant system 105 and the acquirer bank 107 is not necessarily a direct communication and may take various forms. For example, the cardholder and transaction information may be routed through various intermediaries (e.g., payment processors, secured transaction systems, etc.), which may transform, repackage, encrypt, or otherwise reformat the cardholder and transaction information. Further, in practice, the communication that contains the cardholder and transaction information may be referred to as an authorization request for the example transaction, although that communication may take any of various forms and may be transmitted according to any of various communication protocols. In turn, at block 113, the acquirer bank 107 will receive the cardholder and transaction information that is sent by the merchant system 105.

At block 114, the computing platform of the acquirer bank 107 may transmit an authorization request for the example transaction to the issuer bank 108, via a payment network 106. In this respect, the authorization request that is transmitted by the computing platform of the acquirer bank 107 may generally correspond to the authorization request that was received from the merchant system 105, although in practice, it is possible that such authorization request may have different forms and/or may be sent according to different communication protocols.

In turn, at block 116, the computing platform of the issuer bank 108 may receive the authorization request from the computing platform of the acquirer bank 107, via the payment network 106.

At block 117, after receiving the authorization request, the computing platform of the issuer bank 108 may decide whether to approve or deny the example transaction and then generate an authorization response that memorializes the decision. In this respect, the decision of whether to approve or deny the example transaction may be based on the cardholder information and the transaction information. More particularly, the decision of whether to approve or deny the example transaction may involve determining whether the cardholder 102 is capable of legally fulfilling the example transaction with the merchant 104, based on the cardholder information and the transaction information. For example, the computing platform of the issuer bank 108 may determine whether a cardholder account held by the issuer bank 108 contains sufficient funding (money, credit, etc.) to complete the example transaction and/or whether the example transaction would take the cardholder 102 over his or her maximum limit, among other possibilities.

At block 118, after generating the authorization response that memorializes the decision of whether to approve or deny the example transaction, the computing platform of the issuer bank 108 may transmit the authorization response back to the computing platform of the acquirer bank 107, via the payment network 106. In turn, at block 119, the computing platform of the acquirer bank 107 receives the authorization response from the computing platform of the issuer bank 108 and subsequently transmits a corresponding authorization response to the merchant system 105 via a network-based communication path. In this respect, while the authorization responses that are received and transmitted by the computing platform of the acquirer bank 107 correspond to one another, it is possible that such authorization responses may have different forms and/or may be sent according to different communication protocols. Further, it should be understood that the transmission of the authorization response to the merchant system 105 may be routed through one or more intermediaries (e.g., payment processors, secured transaction systems, etc.)

At block 120, the merchant system 105 receives the authorization response from the computing platform of the acquirer bank 107 and presents the authorization response to the cardholder 102 in visual and/or audio form, and at block 121, the cardholder 102 (and/or a representative of the merchant 104) then can view (or hear) the presentation of the authorization response.

As demonstrated by the foregoing discussion, merchant systems play a critical role in the processing of transactions involving payment cards, and as such, it is important to all involved parties (e.g., cardholders, merchants, acquirer banks, issuer banks, etc.) that merchant systems are operating properly. For instance, if a payment terminal such as a contact-based or contactless card reader does not interact properly with other components involved in the end-to-end authorization process for a payment transaction, such as a payment card, a merchant's computing system, a bank's computing platform, and/or a payment processor's computing platform, then this may lead to various problems, including but not limited to processing errors and security issues.

For these and other reasons, payment terminals typically must undergo certification testing before they can be used to initiate the processing of transactions involving payment cards. One example of the type of certification testing that may be performed on payment terminals is EMV Level 3 (L3) testing. In general, certification testing of a payment terminal involves (i) having a tester (e.g., an individual associated with an acquirer bank, a payment processor, a merchant, etc.) initiate test transactions at the payment terminal using test payment cards, (ii) capturing test data related to the test transactions that provides information on the functions that were performed by the payment terminal during the test transactions, including the communications that were sent and received by the payment terminal during processing of the test transactions, and then (iii) performing an analysis of the test data to determine whether the payment terminal operated properly during the test transactions (e.g., whether the payment terminal conforms with the policies and procedures of payment systems).

In order to accomplish certification testing of a payment terminal, an issuer bank typically produces and sends out large batches of physical test cards having different configurations to each respective tester in order to cover a full range of test scenarios, and the testers then use these batches of physical test cards to carry out the test transactions while also utilizing some other system (e.g., a reader and a software tool) to capture the test data related to the test transactions. For instance, each time a test plan for payment terminals is updated, an issuer bank may need to send out a batch of more than 50 physical test cards (e.g., 78 test cards) to each respective tester in order to cover the full range of test scenarios. However, this approach for carrying out certification testing of payment terminals gives rise to a number of problems.

First, requiring an issuer bank to produce and send out large batches of physical test cards to each respective tester every time a payment terminal test plan is updated is costly, inefficient, and wasteful. For instance, this approach requires the issuer bank to incur costs on the resources involved in producing the physical test cards (e.g., materials, labor, etc.) as well as the resources involved in delivering the physical test cards—and those costs are multiplied by the number of testers as well as the number of times that the payment terminal test plan changes. Further, this approach exposes the issuer bank to material shortages—such as shortages in the computer chips that are embedded in the physical test cards—which may delay the production of the physical test cards and perhaps also further increase the cost of supplying the physical test cards. Further yet, this approach introduces delay into the process for performing certification testing of payment terminals once a test plan is updated, because the steps of sourcing the materials, producing the physical test cards, and then delivering the physical test cards to the testers can often take a few weeks, if not longer. Still further, this approach increases the creation of plastic waste, which is undesirable.

Second, under the current approach, the physical test cards are supplied separately from the system that is used to capture the test data, which requires the testers to obtain a system for capturing the test data and confirm that it is approved and suitable for performing the certification testing for payment terminals.

The legacy approach for carrying out certification testing of payment terminals may give rise to several other problems as well.

To overcome these and other problems with the legacy approach for carrying out certification testing of payment terminals, disclosed herein is new software technology for carrying out certification testing of merchant systems that include payment terminals. As described in further detail below, the disclosed software technology may comprise a software application that is installable on a client device and provides the client device with the programmed capability to perform various functionality related to certification testing of payment terminals, including loading virtual test card profiles for use in testing payment terminals and selectively operating in either (i) a card emulation mode in which the client device emulates a physical payment card based on one of the loaded virtual test card profiles in order to carry out testing of a payment terminal while also logging test data for such testing, or (ii) a physical card mode in which the client device wirelessly transfers one of the loaded virtual test card profiles to a configurable payment card that is to be used for testing of a payment terminal and then wirelessly retrieves test data for such testing from the configurable payment card. This software application may be referred to herein as a “certification testing application.”

In accordance with the present disclosure, the functionality provided by the certification testing application for loading virtual test card profiles may take any of various forms. For instance, as a one possibility, the function of loading the virtual test card profiles may involve (i) sending a request for virtual test card profiles to a remote computing platform (e.g., a computing platform associated with an issuer bank) over a network-based communication path and then (ii) receiving a set of virtual test card profiles back from the remote computing platform over the network-based communication path. In this respect, the disclosed software technology may additionally comprise platform-side software for generating, hosting, and distributing virtual test card profiles.

Further, the virtual test card profiles that are utilized by the disclosed software technology may take any of various forms, and in at least some implementations, each such virtual test card profile may comprise a respective data object that includes a respective test card dataset for use in testing a payment terminal. Such a test card dataset may represent any of various types of information for a test card, examples of which may include an indication of a test card type, a card account number, a card account holder name, card account information, one or more identifiers of an issuer (e.g., name, routing number, etc.), and/or one or more identifiers of a payment network (e.g., name, routing number, etc.), among other possibilities.

Further yet, the functionality provided by the certification testing application for selectively operating in a card emulation mode may take various forms. For instance, in some implementations, the functionality carried out by the client device in connection with the card emulation mode may involve (i) receiving a request from a user to operate in a card emulation mode based on a selected one of the loaded virtual test card profiles, (ii) based on the request, emulating a physical test card based on the selected virtual test card profile, (iii) while emulating the physical test card, engaging in wireless communications with a payment terminal (e.g., a contactless card reader) related to a test transaction, and (iv) logging test data related to the test transaction. The functionality provided by the certification testing application for selectively operating in a card emulation mode may take various other forms as well, and is discussed in more detail below.

Still further, the functionality provided by the certification testing application for selectively operating in a physical card mode may take various forms. For instance, in some implementations, the functionality carried out by the client device in connection with the physical card mode may involve (i) receiving a request from a user to operate in a physical card mode based on a selected one of the loaded virtual test card profiles, (ii) based on the request, wirelessly communicating with a configurable test card in order to transfer the selected virtual test card profile (or at least a portion thereof) to the configurable payment card and thereby configure the configurable test card to operate in accordance with the selected virtual test card profile, so that it can be used to carry out contact-based and/or contactless test transactions with the payment terminal, and (iii) wirelessly communicating with the configurable test card in order to obtain test data stored on the configurable test card. In this respect, the configurable payment card may comprise any physical payment card that is capable of receiving and operating in accordance with a virtual test card profile that is loaded onto the configurable payment card. The functionality provided by the certification testing application for selectively operating in a physical card mode may take various other forms as well, and is discussed in more detail below.

In addition to the foregoing functionality, the disclosed certification testing application may also provide functionality for reviewing, analyzing, and reporting test data that has been logged or obtained by the client device in connection with certification testing of payment terminals. For example, the client device installed with the certification testing application may include functionality for one or more of (i) presenting a user of the client device with test data that has been logged or obtained by the client device, (ii) causing test data that has been logged or obtained by the client device to be sent to another party that is involved in the certification testing via some means of communication (e.g., e-mail, text message, etc.), and/or (iii) organizing test data that has been logged or obtained by the client device in accordance with standards for verifying functionality of payment terminals, among other possibilities.

The disclosed certification testing application may provide other functionality as well.

Further, in practice, the users of the disclosed certification testing application may comprise any individuals that are tasked with carrying out certification testing of payment terminals. Such users may include individuals associated with an acquirer bank, a payment processor, and/or a merchant (e.g., employees, contractors, etc.), among various other possibilities.

The disclosed software technology provides various advantages over the legacy approach for carrying out certification testing of payment terminals.

First, the disclosed software technology enables an issuer bank to avoid producing and sending out large batches of physical test cards. Instead, the issuer bank can electronically generate and distribute virtual test card profiles along with a much smaller set of configurable payment cards (e.g., less than 10 per tester), which avoids the various drawbacks of producing and sending out large batches of physical test cards to each respective tester every time a payment terminal test plan is updated—including reducing cost of producing and delivering the cards, avoiding material shortages, reducing the turnaround time for producing and delivering the cards (e.g., from a matter of weeks to a matter of seconds), and reducing the plastic waste that is created.

Second, the disclosed software technology advantageously integrates multiple different sets of functionality related to certification testing into a single software application—including card emulation functionality, physical-card loading functionality, and test data logging functionality, all of which may be carried out based on a common set of virtual test card profiles that are loaded by the software application. In this way, the disclosed software technology enhances the user experience of individuals that are tasked with carrying out certification testing and improves upon existing software applications that only provide a limited set of functionality related to certification testing—such as software applications that allow for capturing of test data but do not provide card emulation functionality or physical-card loading functionality.

The disclosed software technology may provide various other advantages over the legacy approach for carrying out certification testing of payment terminals.

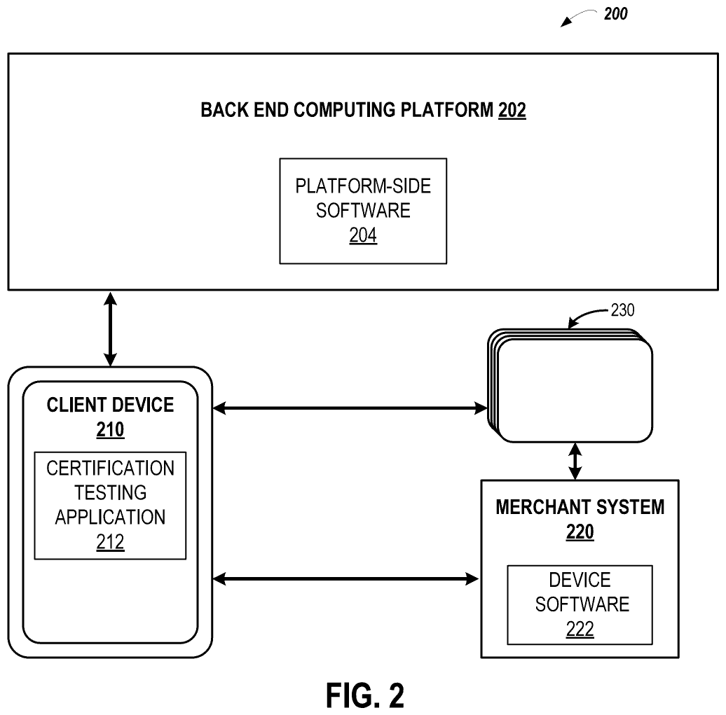

Returning now to the figures, FIG. 2 depicts one illustrative example of a computing environment 200 in which the disclosed certification testing application may be utilized. As shown, the computing environment may include a back-end computing platform 202, a client device 210 that is installed with an instance of the disclosed certification testing application 212, a merchant system 220 that includes a payment terminal, and one or more configurable payment card(s) 230.

The back-end computing platform 202 may comprise any one or more computer systems (e.g., one or more servers) that have been installed with software for carrying out the platform-side functions disclosed herein. In practice, the one or more computer systems of the back-end computing platform 202 may collectively comprise some set of physical computing resources (e.g., one or more processors, data storage systems, communication interfaces, etc.), which may take any of various forms. As one possibility, the back-end computing platform 202 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 202 may comprise “on-premises” computing resources of an organization that operates the back-end computing platform 202 (e.g., servers owned by the organization that operates the back-end computing platform 202). As yet another possibility, the back-end computing platform 202 may comprise a combination of cloud computing resources and on-premises computing resources. Other implementations of the back-end computing platform 202 are possible as well.

Further, in practice, the platform-side software 204 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 2, the platform-side software 204 may interact with a data storage layer of the back-end computing platform 202, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The example back-end computing platform 202 may comprise various other components and take various other forms as well.

Further, the client device 210 may generally take the form of any computing device that is capable of running an instance of the disclosed certification testing application 212, which may take the form of a client application that runs in a web browser, a native desktop application, or a mobile application, among other possibilities. In this respect, the client device 210 may include hardware components such as one or more processors, data storage, communication interfaces, and input/output (I/O) components (or interfaces for connecting thereto), among other possible hardware components, as well as software components such as operating system (OS) software, web browser software, and/or the disclosed certification testing application 212, among other possible software components. As representative examples, the example client device 210 may take the form of a smartphone, a mobile device, a desktop computer, a laptop, a netbook, a tablet, or a personal digital assistant (PDA), among other possibilities.

Further yet the merchant system 220, which may take generally the form of one or more computing devices that are configured to facilitate on-site transactions between consumers and a merchant. For instance, in line with the discussion above, the merchant system 220 may include a payment terminal comprising a contact-based card reader and/or a contactless card reader and perhaps also a computing system that interacts with such a payment terminal in order to control the payment terminal and/or facilitate communication between the payment terminal and a computing platform of an acquirer bank and/or payment processor. The merchant system 220 may take various other forms as well.

Still further, the one or more configurable payment card(s) 230 may each generally take the form of any physical payment card that is capable of receiving and operating in accordance with a virtual test card profile that is loaded onto the configurable payment card 230, such that the configurable payment card 230 can be utilized to test the merchant system 220. In this respect, each configurable payment card 230 may comprise hardware components such as one or more processors, data storage, and one or more communication interfaces, among other possible hardware components, as well as executable software for carrying out the functionality of the configurable payment card 230. The one or more configurable payment card(s) 230 are shown as resembling the shape and size of a typical physical payment card (e.g., credit card, debit card, etc.), such that it may be used in many of the same applications that other physical payment cards are used (e.g., inserted into a card reader device, etc.). However, it should be understood that the one or more configurable payment card(s) 230 may take other forms as well.

As shown in FIG. 2, various of the entities in the example computing environment 200 may be configured to communicate with one another over respective communication paths. For instance, the example client device 210 may be configured to communicate with the back-end computing platform 202 over a respective communication path. This communication path may generally comprise one or more data networks and/or data links, which may take any of various forms. For instance, the communication path between the example client device 210 and the back-end computing platform 202 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between an example client device 210 and the back-end computing platform 202 may be carried out via an Application Programming Interface (API) provided by the back-end computing platform 202, among other possibilities. Although not shown, the respective communication path between the example client device 210 and the back-end computing platform 202 may also include one or more intermediate systems, examples of which may include a data aggregation system or a host server, among other possibilities. Many other configurations are also possible.

Further, the client device 210 may be configured to communicate with the payment terminal of the merchant system 220 and the one or more configurable payment card(s) 230 over respective wireless communication paths. Each such wireless communication path may take any of various forms and carry data according to any of various different communication protocols. For instance, each respective wireless communication path between the client device 210 and the payment terminal of the merchant system 220 or a configurable payment card 230 may include any one or more of a wireless point-to-point link (e.g., radio frequency identification (RFID) link such as a near-field communications (NFC) link, etc.), a wireless PAN (e.g., a Bluetooth® or Zigbee PAN), and/or a wireless LAN (e.g., a WiFi LAN), etc.), among other possibilities. Many other configurations are also possible.

Still further, each configurable payment card 230 may be configured to communicate with the payment terminal of the merchant system 220 over a respective wireless communication path, which may take any of various forms and carry data according to any of various different communication protocols. For instance, the respective wireless communication path between a configurable payment card 230 and the payment terminal of the merchant system 220 may include any one or more of a wireless point-to-point link (e.g., an RFID link such as an NFC link, etc.), a wireless PAN (e.g., a Bluetooth® or Zigbee PAN), and/or a wireless LAN (e.g., a WiFi LAN), among other possibilities. Many other configurations are also possible.

It should be understood that the computing environment 200 is one example of a computing environment in which the disclosed software technology may be implemented, and that numerous other examples of computing environments are possible as well.

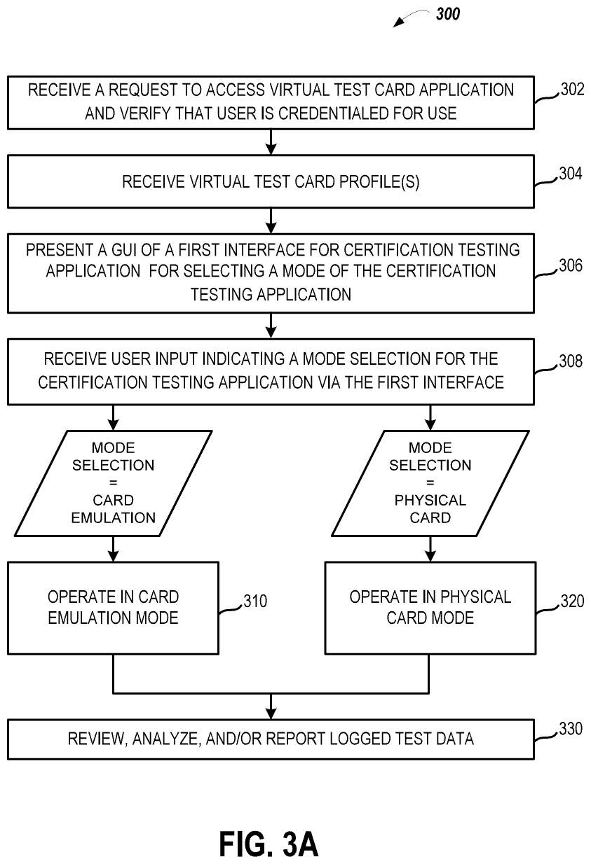

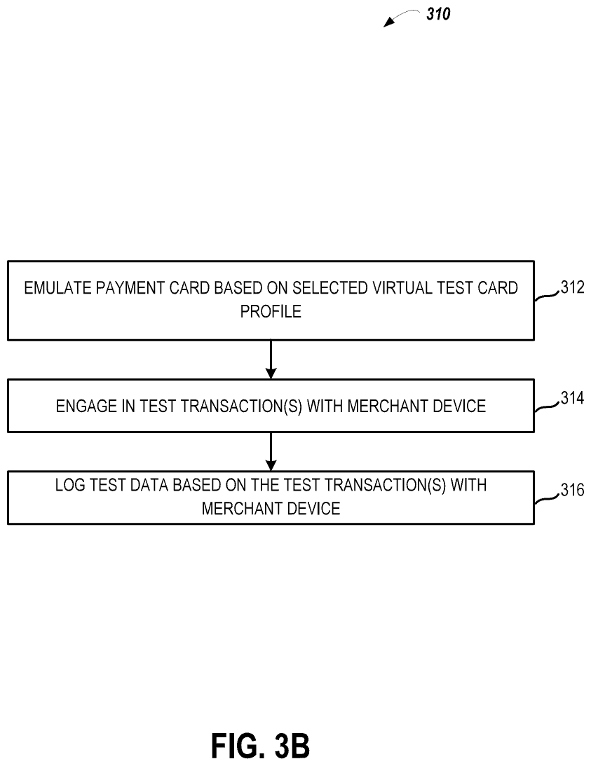

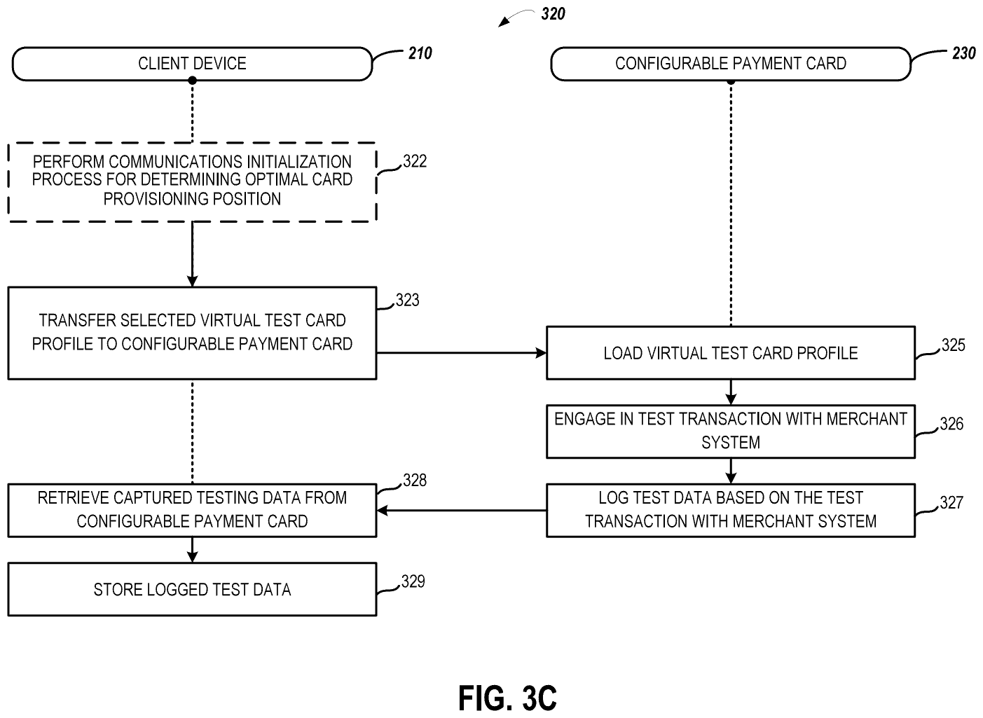

One possible implementation of the functionality that is carried out in accordance with the disclosed software technology is illustrated in FIGS. 3A-C. For purposes of illustration, example functionality 300 of FIG. 3A is described as being carried out by the devices within the example computing environment 200 of FIG. 2, but it should be understood that the example functionality 300 of FIGS. 3A-C may be carried out by any other computing devices, systems, and/or platforms that are capable of implementing the disclosed software technology. Further, it should be understood that the example functionality of FIGS. 3A-C is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

As shown in FIG. 3A, the example functionality 300 may begin at block 302 with the client device 210 receiving a request from a user of the client device 210 to access the certification testing application (e.g., via the I/O interface of the client device 210). In some examples, the request that is received by the client device 210 may include identifying information and/or security credentials (e.g., a username and password, a security token, etc.) for the user, among other possible information that may be included in the request. In some such examples, the client device 210 may provide the identifying information and/or security credentials to the back-end computing platform 202, for verification. In practice, this request may take the form of one or more request messages (e.g., one or more HTTP messages) that are sent over the respective communication path between the client device 210 and the back-end computing platform 202 (which as noted above may include at least one data network), and in at least some implementations, the one or more request messages may be sent via an API. The request to access the certification testing application may take other forms and/or be received in other manners as well.

At block 304, the client device 210 installed with the certification testing application may load a set of one or more virtual test card profiles for use in testing payment terminals. This function of loading the one or more virtual test card profiles, by the client device 210, may take any of various forms. For instance, as one possibility, the function of loading the set of one or more virtual test card profiles may involve the client device 210 (i) sending a request to the back-end computing platform 202 for one or more virtual test card profiles over the respective communication path between the client device 210 and the back-end computing platform 202, (ii) as a result of sending the request, receiving a given set one or more virtual test card profiles from the back-end computing platform 202 over the respective communication path between the client device 210 and the back-end computing platform 202, and (iii) storing the given set of one or more virtual test card profiles within the local data storage of the client device 210. In this respect, the back-end computing platform 202 may be provisioned with back-end software for generating, storing, and/or distributing virtual test card profiles for use in testing payment terminals. The function of loading the set of one or more virtual test card profiles by the client device 210 may take various other forms as well.

Further, the client device 210 may load the set of one or more virtual test card profiles at any of various times and/or in response to any of various triggering events. For instance, as one possibility, the client device 210 may be configured to load the set of one or more virtual test card profiles in response to a request by a user. As another possibility, the client device 210 may be configured to load the set of one or more virtual test card profiles in response to determining that a user is authorized to use the test certification application (which as noted above may involve verification by the back-end computing platform 202). As yet another possibility, the client device 210 may be configured to load the set of one or more virtual test card profiles in response to detecting a notification that an updated set of one or more virtual test card profiles is available for loading by the client device 210 (e.g., based on a communication received from the back-end computing platform 202). The client device 210 may load the set of one or more virtual test card profiles at other times and/or in response to other triggering events as well.

It should also be understood that the client device 210 may load different sets of one or more virtual test card profiles at different times. For instance, the client device 210 may load a first set of one or more virtual test card profiles at a first time, and then if the back-end computing platform 202 thereafter generates an updated set of one or more virtual test card profiles that are to be used during another round of certification testing (e.g., based on an updated test plan), the client device 210 may load a second set of one or more virtual test card profiles at a second time in the future. Notably, the ability to have the client device 210 load different sets of one or more virtual test card profiles by virtue of engaging in communication with the back-end computing platform 202 enables testers to quickly and efficiently access and use new test cards in a way that is less costly, less time consuming, and less wasteful than supplying the testers with physical test cards.

At block 306, the client device 210 installed with the certification testing application may present a user of the client device 210 (e.g., a testing party) with a first view of a graphic user interface (GUI) for the certification testing application that enables a user to input a selection of an operating mode of the certification testing application, and more specifically, to select between a card emulation mode and a physical card mode. Additionally, in some examples, the first GUI view may enable the user to input a selection of a given virtual test card profile from the loaded set of one or more virtual test card profiles. In this respect, the virtual test card profiles that are presented for selection by the user may comprise the entire set of one or more virtual test card profiles that were loaded by the client device 210, or some subset thereof. For instance, in some implementations, the client device 210 installed with the certification testing application may be configured to present different virtual test card profiles for selection depending on which operating mode of the certification testing application has been selected, among other possible factors that may be utilized to determine which virtual test card profiles are presented for selection.

In practice, the first GUI view may include various GUI input elements (e.g., buttons, text input fields, dropdown lists, slider bars, etc.) that enable the user to input one or more of a selection for the operating mode of the certification testing application and a selection of a given virtual test card profile.

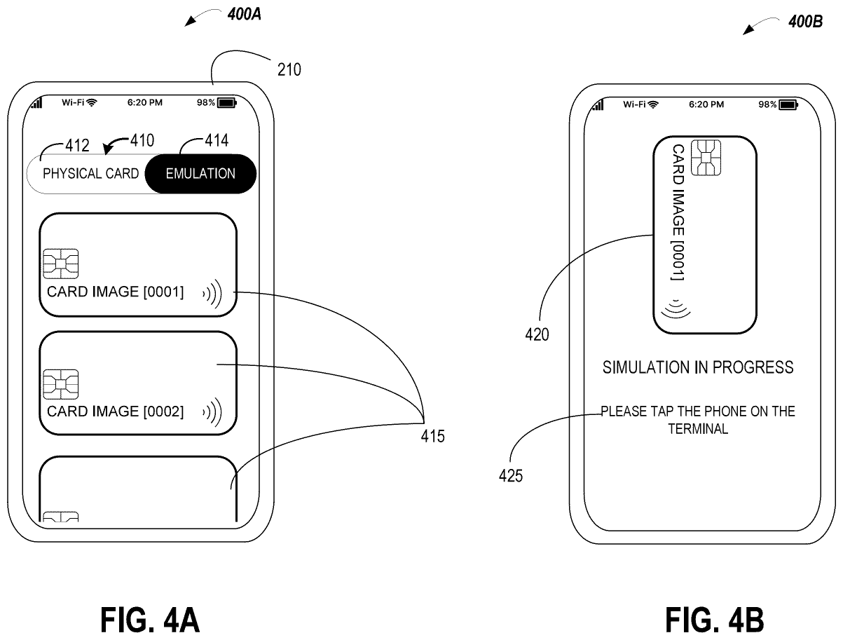

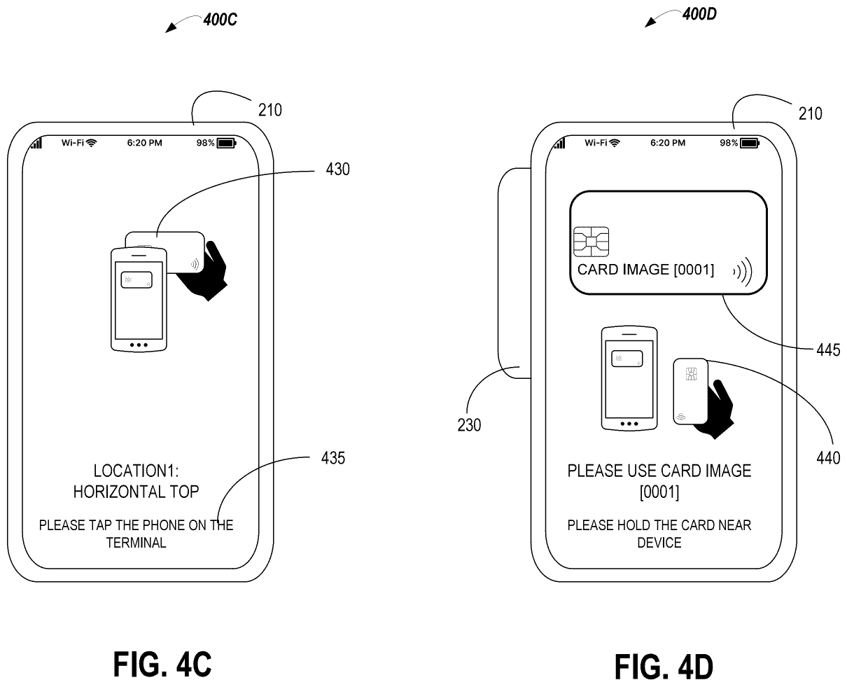

One representative example of the first GUI view that may be presented by the client device 210 installed with the certification testing application 212 is illustrated in FIG. 4A.

As shown in FIG. 4A, the example first GUI view 400A may include a selector input 410 that enables a user to select between a card emulation mode 412 or a physical card mode selection 414 by via a click or touch input. For instance, if a user clicks, touches, or slides towards the GUI element representing the card emulation mode 412, the client device 210 installed with the certification testing application 212 may interpret and process such user input as a selection of the card emulation mode 412, whereas if a user clicks, touches, or slides towards the GUI element representing the physical card mode selection 414, the client device 210 installed with the certification testing application 212 may interpret and process such user input as a selection of the physical card mode selection 414. The selector input 410 and the manner in which a user interacts with the selector input 410 may take various other forms as well.

Additionally, the first GUI view 400A may include visual representations of a plurality of virtual test card profiles (i.e., “virtual-test-card-profile representations”) 415, of which three examples are shown in FIG. 4A. The plurality of virtual-test-card-profile representations 415 may be selectable, such that a user of the client device 210 can select a given virtual test card profile, via an input associated with a given visual representation of the plurality of virtual-test-card-profile representations 415 that is associated with the given virtual test card profile (e.g., a click or touch input). While the virtual-test-card-profile representations 415 are illustrated as visual depictions that resemble a physical payment card, in some other examples, the virtual-test-card-profile representations 415 may take various other forms (e.g., plain text or in other graphic depictions).

Further, the virtual-test-card-profiles representations 415 may be presented via the first GUI view 400A in any organized or filtered form, from which a user may select a given virtual test card profile based on a selection of a virtual-test-card-profile representation 415. To that end, it is contemplated that a GUI, presented by a client device executing the certification testing application 212, may include one or more input elements (e.g., drop down menus, check boxes, sliders, etc.) configured to filter one or more virtual-test-card-profile representations 415 based on, for example, a card type associated with each of the one or more virtual-test-card-profile representations 415. The virtual-test-card-profile representations 415, in preparation for selection by a user, may be filtered or otherwise organized or reorganized in various other forms as well.

Notably, this functionality of enabling a user to select between different operating modes and then select from the loaded set of one or more virtual test card profiles may enhance the user experience of a tester that is tasked with performing certification testing of the merchant system 220, because the tester can utilize a single software application and GUI to carry out testing using either the client device 210 itself (if card emulation mode is selected) or a configurable test card (if physical card mode is selected) while leveraging a common set of virtual test card profiles.

Returning now to FIG. 3A, at block 308, the client device 210 installed with the certification testing application may receive user input indicating (i) a first selection of an operating mode of the certification testing application, and more specifically, a selection between a card emulation mode and a physical card mode, and (ii) a second selection of a virtual test card profile for use in testing a payment terminal. For instance, in line with the discussion above, the client device 210 may receive user input indicating the selections of the operating mode of the certification testing application and the virtual test card profile via the first GUI view, which may be presented by the client device 210 installed with the certification testing application. In this respect, the user input that is received via the first GUI view in order to select the operating mode of the certification testing application and the virtual test card profile may take any of the various forms discussed above.

The client device 210 may receive the user input indicating the selection of the operating mode of the certification testing application and the virtual test card profile in various other forms, as well. For instance, instead of receiving both the first selection of the operating mode of the certification testing application and the second selection of the virtual test card profile via the same GUI view, it is possible that the client device 210 installed with the certification testing application may present separate GUI views for making these selections (e.g., a first GUI view for selecting the operating mode and a second GUI view for selecting a virtual test card profile that is presented after the operating mode is selected, or vice versa) and may thus receive the selections via separate GUI views. Other examples are possible as well.

If the client device 210 receives user input indicating a selection of the card emulation mode, then, at block 310, the client device 210 may carry out functionality for emulating a physical payment card based on the selected virtual test card profile in order to carry out testing of a payment terminal while also logging test data for such testing. The functionality 310 that is carried out by the client device 210 installed with the certification testing application while operating in the card emulation mode may take any of various forms, and one possible example of the card-emulation functionality of block 310 is illustrated in further detail in FIG. 3B.

As shown in FIG. 3B, the functionality 310 that is carried out by the client device 210 installed the certification testing application while operating in the card emulation mode may begin at block 312 with the client device 210 configuring itself to emulate a contactless payment card having the card information that is included in the selected virtual test card profile. This function may take any of various forms, and at a high level, may involve the client device 210 entering a mode in which it can be detected by a contactless card reader via a wireless protocol such as RFID (e.g., NFC), Bluetooth®, Zigbee, or the like, and can thereafter engage in wireless communication with the contactless card reader.

At block 314, while emulating the contactless payment card having the card information included in the selected virtual test card profile, the client device 210 may engage wireless communications with the payment terminal of the merchant system 220 for purposes of processing a test transaction. For instance, after the payment terminal of the merchant system 220 is used to initiate the test transaction and the client device 210 emulating the contactless payment card is detected by the payment terminal via a contactless card reader or the like, the client device 210 emulating the contactless payment card may wirelessly exchange a series of messages with the payment terminal of the merchant system 220 in order to facilitate processing of the test transaction. These messages may take any of various forms and may be compliant with any of various standards, examples of which may include the ISO/IEC 14443 standard and/or the ISO 7816 standard.

To illustrate with one possible example, the wireless communication with the payment terminal of the merchant system 220 may begin with the exchange of a sequence of SELECT messages, which may include (i) a SELECT Proximity Payment System Environment (PPSE) command that is sent from the contactless card reader to the client device 210, (ii) a SELECT response comprising the File Control Information (FCI) of the PPSE that is sent from the client device 210 back to the contactless card reader, (iii) a SELECT Application command that is sent from the contactless card reader to the client device 210, and (iv) a SELECT response comprising the FCI of the Application ID (AID) that is sent from the client device 210 back to the contactless card reader. After the sequence of SELECT messages has been exchanged, the contactless card reader may send a GET Processing Options (GPO) command to the client device 210, which contains data related to the transaction such as the transaction amount, transaction date, transaction type, currency code, country code, the card contactless reader's terminal transaction qualifier (TTQ), and an unpredictable number. In turn, the client device 210 may generate a cryptogram for the transaction and send a GPO response to the contactless card reader that contains the generated cryptogram for the transaction along with other information for use in processing the transaction (e.g., a tokenized version of the card number). Thereafter, the merchant system 220 may generate and send out an authorization request for the test transaction to a computing platform of an acquirer bank or a processor associated therewith.

The wireless communication between the client device 210 and the payment terminal of the merchant system 220 may take various other forms as well.

At block 316, while emulating the contactless payment card and engaging in the wireless communications with the payment terminal of the merchant system 220, the client device 210 may also log test data associated with the test transaction, which may take any of various forms. As one possibility, the logged test data may include information about the wireless communications exchanged between the client device 210 and the payment terminal of the merchant system 220, including but not limited to the types of messages that are exchanged, the timestamps of the messages that are exchanged, and/or the contents of the messages that are exchanged, among other possible types of information about the wireless communications exchanged between the client device 210 and the merchant system 220. As another possibility, the logged test data may include information about the client device 210 and/or the payment terminal involved in the wireless communications. The logged test data may include various other types of information as well.

Further, in practice, the client device 210 may store the logged test data in its data storage in any of various forms. For instance, as one possibility, the logged test data may be stored in the form of a data file, such as an XML file, among various other possible examples of data file types that may be used to store logged test data.

The function of the testing data by the client device 210 may take various other forms as well.

While performing the card-emulation functionality or block 310 described above, the client device 210 installed with the certification testing application may also present a second GUI view to indicate that the client device 210 is emulating a contactless payment card having the card information included in the selected virtual test card profile. One representative example of the second GUI view that may be presented by the client device 210 installed with the certification testing application 212 is illustrated in FIG. 4B. As shown in FIG. 4B, the example second GUI view 400B may include a visual representation 420 of the selected virtual test card profile along with a textual indication that the client device 210 is emulating a contactless payment card having the card information included in the given virtual test card profile represented by the representation 420. Optionally, the example second GUI view 400B may also include user instructions 425 for carrying out the testing of the merchant system 220, such as instructions for tapping the client device 210 onto the contactless card reader of the merchant system's payment terminal. The second GUI view 400B may take various other forms as well.

Returning back to block 308 of FIG. 3A, if the client device 210 receives user input indicating a selection of the physical card mode, then, at block 320, the client device 210 may carry out functionality for wirelessly transferring the selected virtual test card profile to a configurable payment card 230 that is to be used for testing of a merchant system and then wirelessly retrieving logged test data for such testing from the configurable payment card 230. The functionality of block 320 that is carried out by the client device 210 installed with the certification testing application while operating in the physical card mode is illustrated in further detail in FIG. 3C.

As shown in FIG. 3C, functionality of block 320 that is carried out by the client device 210 installed with the certification testing application while operating in the physical card mode may optionally begin at block 322 with the client device 210 performing a calibration process for determining an optimal positioning of a configurable payment card 230 relative to the client device 210 in order to facilitate wireless communication between the client device 210 and the configurable payment card 230. This calibration process may take any of various forms.

As one possibility, the client device 210 may instruct a user of the client device to position a configurable payment card 230 at a plurality of positions in proximity to the client device (e.g. proximate to the top of the client device 210, proximate to the bottom of the client device 210, proximate to the right side of the client device 210, proximate to the left side of the client device 210, proximate to a center of the client device 210, proximate to a rear-center of the client device 210, etc.), and while the configurable payment card 230 is placed at each respective position, the client device 210 may attempt to wirelessly communicate with the configurable payment card 230 (e.g., via RFID/NFC). If the user has followed the client device 210 instructions during the calibration process, then, based on data collected during the calibration process, the client device 210 may (i) determine an optimal positioning relative to the client device 210, at which a user should position a configurable payment card 230 to load a virtual test card profile thereon, and (ii) present the determined optimal positioning as a recommendation to the user for where to position a configurable payment card 230 relative to the client device 210. The data collected during the calibration process may be, for example, data indicative of the wireless connection strength (e.g., how long it took to wirelessly detect the configurable payment card 230) at each of the plurality of positions in proximity to the client device 210.

The calibration process may take various other forms as well.

One representative example of a third GUI view that may be presented by the client device 210 installed with the certification testing application 212 while performing a calibration process is illustrated in FIG. 4C. As shown, with the example third GUI view 400C may include visual instructions 430 and/or textual instructions 435 to assist a user for positioning the configurable payment card 230 to properly execute the calibration process. The GUI views that are presented to a user during the calibration process may take various other forms, as well.

While an optional process, performing the functionality of block 322 may improve performance of the wireless communication between the client device 210 and the one or more configurable payment card(s) 230.

Returning now to FIG. 3C, at block 323, the client device 210 wirelessly communicates with a given configurable payment card 230 that is to be used for testing of the merchant system 220 in order to transfer the selected virtual test card profile (or at least a portion thereof) to the given configurable payment card 230. For instance, after the client device 210 receives the user's selections of the physical card mode and the virtual test card profile, the client device 210 may monitor for a configurable payment card 230 in proximity of the client device 210, and upon detecting the given configurable payment card 230, the client device 210 may initiate the wireless communication with the given configurable payment card 230 (e.g., via RFID/NFC) in order to transfer the selected virtual test card profile (or at least a portion thereof) to the given configurable payment card 230. The wireless communication between the client device 210 and the given configurable payment card 230 for transferring the selected virtual test card profile may take any of various forms.

In conjunction with transferring the selected virtual test card profile to the given configurable payment card 230, the client device 210 may present a fourth GUI view that provides user instructions for carrying out that function. One representative example of the fourth GUI view that may be presented by the client device 210 installed with the certification testing application 212 is illustrated in FIG. 4D. As shown FIG. 4D, the example fourth GUI view 400D may include user instructions 440 for positioning the given configurable payment card 230 relative to the client device and perhaps also a visual representation 445 of the selected virtual test card profile, which indicates that the virtual test card profile (or at least a portion thereof) is being transferred to the given configurable payment card 230. The fourth GUI view may take various other forms, as well.

Returning now to FIG. 3C and referring to block 325, after the given configurable payment card 230 is loaded with the selected virtual test card profile (or at least a portion thereof), the given configurable payment card 230 may then store the virtual test card profile in its local data storage and begin operating in accordance with the selected virtual test card profile by acting as a physical card having the card information included in the selected virtual test card profile. In this respect, it may thereafter be possible to use the given configurable payment card 230 for a test transaction with the merchant system 220.

At block 326, while the given configurable payment card 230 is operating in accordance with the selected virtual test card profile, the given configurable payment card 230 may engage in wired (i.e., contact-based) or wireless (i.e., contactless) communications with the payment terminal of the merchant system 220 for purposes of processing a test transaction. For instance, after the merchant system 220 is used to initiate the test transaction and the given configurable payment card 230 is detected by the payment terminal of the merchant system 220 via a contact-based or contactless card reader or the like, the given configurable payment card 230 may exchange a series of messages with the payment terminal of the merchant system 220 in order to facilitate processing of the test transaction. These messages may take any of various forms and may be compliant with any of various standards, examples of which may include the ISO/IEC 14443 standard and/or the ISO 7816 standard. One possible example of such communication is described above in the context of the communication between a client device 210 emulating a contactless payment card and a contactless card reader.

At block 327, while operating in accordance with the selected virtual test card profile and engaging in the wired or wireless communications with the payment terminal of the merchant system 220, the given configurable payment card 230 may log test data associated with the test transaction, which may take any of various forms—including but not limited to the forms of logged test data described above in connection with the card emulation mode. Further, in practice, the given configurable payment card 230 may store the logged test data in its data storage in any of various forms. For instance, as one possibility, the logged test data may be stored in the form of a data file, such as an XML file, among various other possible examples of data file types that may be used to store logged test data.

After the given configurable payment card 230 may log test data associated with the test transaction, the client device 210 may receive a user request to retrieve the logged test data from the given configurable payment card 230 (e.g., via a GUI view that includes a selectable option for retrieving logged test data).

At block 328, based on the user request, the client device 210 may then engage in wireless communications with the given configurable payment card 230 (e.g., via RFID/NFC) in order to retrieve the logged test data from the given configurable payment card 230. For example, the client device 210 may begin by monitoring for the given configurable payment card 230 (e.g., via a polling mechanism or the like), and if the given configurable payment card 230 is detected, the client device 210 may then (i) wirelessly transmit a request to the configurable payment card 230 for the logged test data that is stored on the configurable payment card 230 and (ii) wirelessly receive a response from the configurable payment card 230 that includes a copy of the logged test data stored on the given configurable payment card 230. The function of retrieving the logged test data, by the client device 210, may take various other forms as well.

After the logged test data is retrieved by the client device 210, at block 329, the client device 210 may then store the logged test data in its data storage.

Notably, the functionality of 320 can be repeated multiple times in order to load the given configurable payment card 230 with (and thereby cause given configurable payment card 230 to operate in accordance with) the multiple different virtual test card profiles that can be utilized to test the merchant system.

Returning now to FIG. 3A, after testing is performed and test data is logged and stored, using either the card emulation mode or the physical card mode, the client device 210 installed with the certification testing application may also provide functionality that enables a user of the client device 210 to review, analyze, and/or report the logged test data (block 330). For example, the client device 210 may receive a request from a user to present the logged test data via another GUI view of the certification testing application. In another example, the client device 210 may cause the logged test data to be to sent to another party that is involved in the certification testing via some means of communication (e.g., e-mail, text message, etc.), which may involve transmitting the logged test data to a remote computing platform via a network-based communication path. In yet another example, the client device 210 may organize the logged test data in accordance with standards for verifying functionality of merchant systems and providing the data to a computing platform associated with an entity associated with these standards. The functionality that enables a user of the client device 210 to review, analyze, and/or report the logged test data may take various other forms as well.

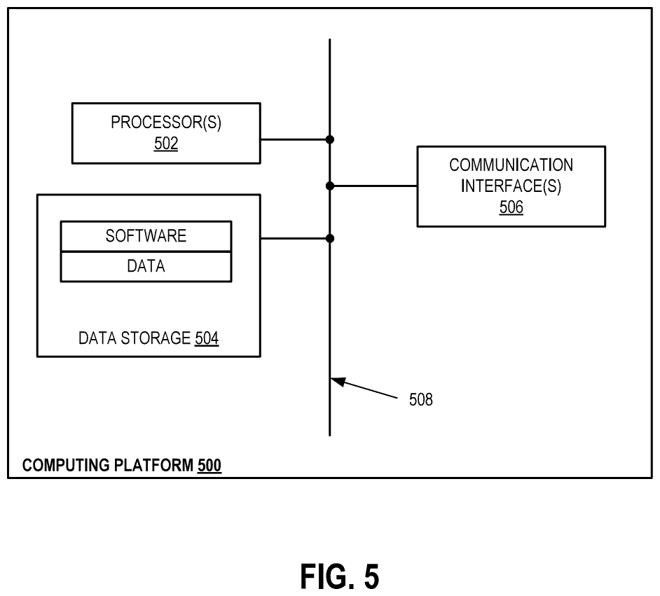

Turning now to FIG. 5, a simplified block diagram is provided to illustrate some structural components that may be included in an example computing platform 500 that may be configured to perform some or all of the platform-side functions disclosed herein. At a high level, computing platform 500 may generally comprise any one or more computer systems (e.g., one or more servers) that collectively include one or more processors 502, data storage 504, and one or more communication interfaces 506, all of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing units (GPUs), application-specific integrated circuits (ASICs), digital signal processors (DSPs), and/or programmable logic devices such as field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, data storage 504 may be capable of storing both (i) program instructions that are executable by the one or more processors 502 such that the computing platform 500 is configured to perform any of the various functions disclosed herein (including but not limited to any of the server-side functions discussed above), and (ii) data that may be received, derived, or otherwise stored by computing platform 500.

The one or more communication interfaces 506 may comprise one or more interfaces that facilitate communication between the computing platform 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the computing platform 500 may additionally have an I/O interface that includes or provides connectivity to I/O components that facilitate user interaction with the computing platform 500, such as a keyboard, a mouse, a trackpad, a display screen, a touch-sensitive interface, a stylus, a virtual-reality headset, and/or one or more speaker components, among other possibilities.

It should be understood that computing platform 500 is one example of a computing platform that may be used with the embodiments described herein. Numerous other arrangements are possible and contemplated herein. For instance, in other embodiments, the computing platform 500 may include additional components not pictured and/or more or less of the pictured components.

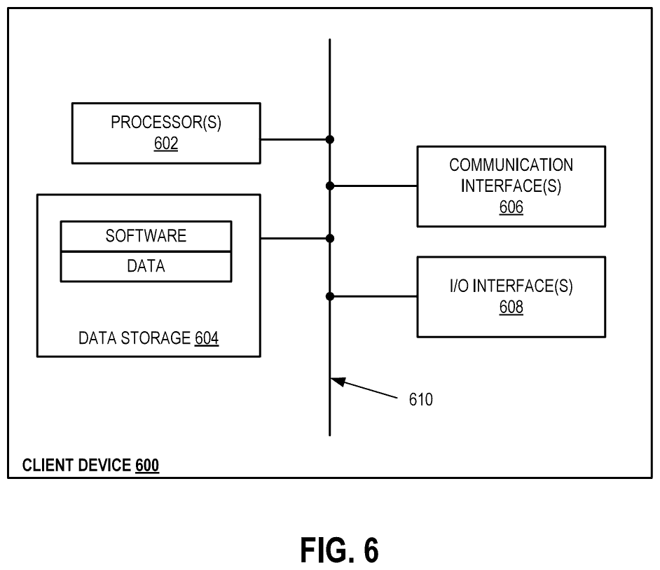

Turning next to FIG. 6, a simplified block diagram is provided to illustrate some structural components that may be included in an example client device 600 that may be configured to perform some or all of the client-side functions disclosed herein. At a high level, the example client device 600 may include one or more processors 602, data storage 604, one or more communication interfaces 606, and an I/O interface 608, all of which may be communicatively linked by a communication link 610 that may take the form a system bus and/or some other connection mechanism. Each of these components may take various forms.

For instance, the one or more processors 602 of the example client device 600 may comprise one or more processor components, such as one or more CPUs, GPUs, ASICs, DSPs, and/or programmable logic devices such as FPGAs, among other possible types of processing components.

In turn, the data storage 604 of the example client device 600 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 6, data storage 604 may be capable of storing both (i) program instructions that are executable by the one or more processors 602 of the example client device 600 such that the client device 600 is configured to perform any of the various functions disclosed herein (including but not limited to any of the client-side functions discussed above), and (ii) data that may be received, derived, or otherwise stored by the client device 600.

The one or more communication interfaces 606 may comprise one or more interfaces that facilitate communication between the client device 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 608 may generally take the form of (i) one or more input interfaces that are configured to receive and/or capture information at the example client device 600 and (ii) one or more output interfaces that are configured to output information from the example client device 600 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of I/O interface may include or provide connectivity to output components such as a display screen and/or an audio speaker, among other possibilities.

It should be understood that the example client device 600 is one example of a client device that may be used with the example embodiments described herein. Numerous other arrangements are possible and contemplated herein. For instance, in other embodiments, the example client device 600 may include additional components not pictured and/or more or fewer of the pictured components.

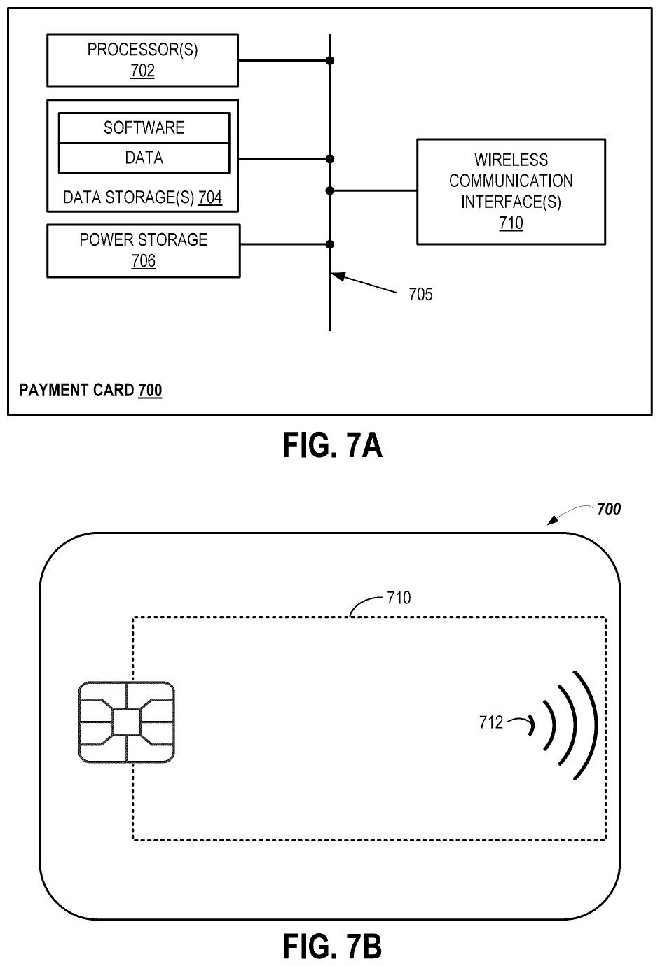

Turning next to FIG. 7A, a simplified block diagram is provided to illustrate some structural components that may be included in an example payment card 700 that may be configured to perform some or all of the configurable payment-card functions disclosed herein. At a high level, the payment card 700 may include one or more processor(s) 702, data storage 704, power storage 706, and one or more wireless communication interfaces 710, each of which may be communicatively linked by a communication link 705 that may take the form an electrical connection, communication bus, and/or some other connection mechanism. Each of these components may take various forms, and may be integrated together in whole or in part (e.g., as part of an integrated circuit, a microchip, or the like).

For instance, the one or more processors 702 of the example payment card 700 may comprise one or more processor components, such as one or more CPUs, ASICs, DSPs, and/or programmable logic devices such as FPGAs, among other possible types of processing components.

In turn, the data storage c704 may include one or more non-volatile storage mediums and one or more non-volatile storage mediums, which may be collectively capable of storing both (i) program instructions that are executable by the one or more processors 702 such that the payment card 700 is configured to perform any of the various payment-card functions disclosed herein, and (ii) data that may be received, derived, or otherwise stored by the payment card 700 in accordance with the present disclosure (e.g., virtual test card profiles).

The power storage 706 may comprise any power-storage component (e.g., a capacitor, a battery) that serves to supply power to the various components of the payment card 700 for performing one or more of the functions described herein. Such a power-storage component may source power from external sources, such as an external battery or a battery-powered computing device that the payment card 700 can directly or indirectly connect to, such as a merchant system or a client device. In some implementations, the payment card 700 may alternatively or additionally comprise a battery component that serves to receive and supply power to the various components of the payment card 700. Such a battery component may take any of various forms now known or later discovered, including an embedded rechargeable battery, such as a solar strip or cell, among other possibilities. In some other implementations, the payment card 700 may be capable of inductive power receipt or charging of the power storage 706. For example, the power storage 706 may include integrated or discrete circuitry (e.g., a rectifier, etc.) configured to harvest usable electrical energy from electrical signals communicated to/from the payment card 700 via the wireless communication interface 710.

The one or more wireless communication interfaces 710 may comprise one or more interfaces that facilitate communication between the payment card 700 and another device (e.g., a client device or a merchant system), where each such interface may communicate according to any of various wireless communication protocols. As examples, the one or more wireless communication interfaces 710 may take include an antenna and associated circuitry that is adapted to facilitate any of various types of wireless communication (e.g., RFID/NFC communication), and/or any other interface that provides for wireless communication. Other configurations are possible as well.

FIG. 7B depicts a top view of the example payment card 700 that may be configured to perform some or all of the configurable payment card functions disclosed herein. In the example of FIG. 7, the payment card 700 is shown to resemble the shape and size of a physical payment card (e.g., credit card, debit card, etc.), such that it may be used in many of the same applications that other physical payment cards are used (e.g., inserted into a card reader device, tap to pay, etc.). However, it should be understood that the payment card 700 may take various physical forms.

Certain physical components of the example payment card 700 may be exposed through the outer surface such that they are visible and/or accessible to a tester, while certain physical components of the example payment card 700 may be completely or partially concealed by the outer surface. Further, for certain physical components that may be concealed, the outer surface of the example payment card 700 may comprise the visual indicator 712, indicating the presence of the certain physical components. The visual indicator 712 may be useful to inform the card member of functionality that is made available by the concealed physical components. For example, the visual indicator 712 may be indicative of a location of an antenna of the wireless communication interface 710, or a portion thereof, that enables optimal communication between the payment card 700 and a merchant system.

It should be understood that the example payment card 700 is one example of a payment card that may be used with the example embodiments described herein. Numerous other arrangements are possible and contemplated herein. For instance, in other embodiments, the example payment card 700 may include additional components not pictured and/or more or fewer of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

I claim:

1. A client device comprising:
at least one communication interface;
at least one processor; and
at least one non-transitory computer-readable medium having stored thereon a software application for use in performing testing of payment terminals, the software application comprising program instructions that, when executed by the at least one processor, cause the client device to:
load a set of virtual test card profiles;
present a graphical user interface (GUI) of the software application that enables selection of (i) an operating mode for use in testing a given payment terminal and (ii) a virtual test card profile for use in testing the given payment terminal;
receive, via the GUI of the software application, (i) a first user selection of a given operating mode for use in testing the given payment terminal and (ii) a second user selection, from the loaded set of virtual test card profiles, of a given virtual test card profile for use in testing the given payment terminal; and
based on the first and second user selections, selectively operate in either:
(i) a first operating mode in which the client device emulates a physical payment card in accordance with the given virtual test card profile; or
(ii) a second operating mode in which the client device configures a configurable payment card to operate in accordance with the given virtual test card profile.

2. The client device of claim 1, wherein:
while selectively operating in the first operating mode, the client device logs test data related to a test transaction between the client device and the given payment terminal; and
while selectively operating in the second operating mode, the client device wirelessly retrieves, from the configurable payment card, test data related to a test transaction between the configurable payment card and the given payment terminal.

3. The client device of claim 2, wherein the software application further comprises program instructions that, when executed by the at least one processor, cause the client device to:
present, via the GUI of the client device, one or both of (i) test data logged by the client device or (ii) test data retrieved from the configurable payment card.

4. The client device of claim 2, wherein the software application further comprises program instructions that, when executed by the at least one processor, cause the client device to:
transmit, to a remote computing system, one or both of (i) test data logged by the client device or (ii) test data retrieved from the configurable payment card.

5. The client device of claim 1, wherein the program instructions that, when executed by the at least one processor, cause the client device to selectively operate in the first operating mode in which the client device emulates the physical payment card in accordance with the given virtual test card profile comprise program instructions that, when executed by the at least one processor, cause the client device to:
engage in wireless communications with the given payment terminal related to a test transaction between the client device and the given payment terminal.

6. The client device of claim 5, wherein the wireless communications are sent over a near field communications (NFC) link between the client device and the given payment terminal.

7. The client device of claim 1, wherein the program instructions that, when executed by the at least one processor, cause the client device to selectively operate in the second operating mode in which the client device configures the configurable payment card to operate in accordance with the given virtual test card profile comprise program instructions that, when executed by the at least one processor, cause the client device to:
wirelessly transfer at least a portion of the given virtual test card profile to the configurable payment card.

8. The client device of claim 7, wherein the portion of the given virtual test card profile is wirelessly transferred over a near field communications (NFC) link between the client device and the configurable payment card.

9. The client device of claim 1, wherein the software application further comprises program instructions that, when executed by the at least one processor, cause the client device to:
determine an optimal location for positioning a configurable payment card relative to the client device when selectively operating in the second operating mode.

10. The client device of claim 7, wherein the GUI of the software application comprises:
a respective selectable GUI element for each of the first operating mode and the second operating mode; and
a respective selectable GUI element for each virtual test card profile in the set of virtual test card profiles.

11. A non-transitory computer-readable medium, having stored thereon a software application for use in performing testing of payment terminals, the software application comprising program instructions that, when executed by at least one processor, cause a client device to:
load a set of virtual test card profiles;
present a graphical user interface (GUI) of the software application that enables selection of (i) an operating mode for use in testing a given payment terminal and (ii) a virtual test card profile for use in testing the given payment terminal;
receive, via the GUI of the software application, (i) a first user selection of a given operating mode for use in testing the given payment terminal and (ii) a second user selection, from the loaded set of virtual test card profiles, of a given virtual test card profile for use in testing the given payment terminal; and
based on the first and second user selections, selectively operate in either:
(i) a first operating mode in which the client device emulates a physical payment card in accordance with the given virtual test card profile; or
(ii) a second operating mode in which the client device configures a configurable payment card to operate in accordance with the given virtual test card profile.

12. The non-transitory computer-readable medium of claim 11, wherein
while selectively operating in the first operating mode, the client device logs test data related to a test transaction between the client device and the given payment terminal; and
while selectively operating in the second operating mode, the client device wirelessly retrieves, from the configurable payment card, test data related to a test transaction between the configurable payment card and the given payment terminal.

13. The non-transitory computer-readable medium of claim 12, wherein the software application further comprises program instructions that, when executed by the at least one processor, cause the client device to:
present, via the GUI of the client device, one or both of (i) test data logged by the client device or (ii) test data retrieved from the configurable payment card.

14. The non-transitory computer-readable medium of claim 12, wherein the software application further comprises program instructions that, when executed by the at least one processor, cause the client device to:
transmit, to a remote computing system, one or both of (i) test data logged by the client device or (ii) test data retrieved from the configurable payment card.

15. The non-transitory computer-readable medium of claim 11, wherein the program instructions that, when executed by the at least one processor, cause the client device to selectively operate in the first operating mode in which the client device emulates the physical payment card in accordance with the given virtual test card profile comprise program instructions that, when executed by the at least one processor, cause the client device to:
engage in wireless communications with the given payment terminal related to a test transaction between the client device and the given payment terminal.

16. The non-transitory computer-readable medium of claim 11, wherein the program instructions that, when executed by the at least one processor, cause the client device to selectively operate in the second operating mode in which the client device configures the configurable payment card to operate in accordance with the given virtual test card profile comprise program instructions that, when executed by the at least one processor, cause the client device to:
wirelessly transfer at least a portion of the given virtual test card profile to the configurable payment card.

17. A method implemented by a client device, the method comprising:
loading a set of virtual test card profiles;
presenting a graphical user interface (GUI) that enables selection of (i) an operating mode for use in testing a given payment terminal and (ii) a virtual test card profile for use in testing the given payment terminal;
receiving, via the GUI, (i) a first user selection of a given operating mode for use in testing the given payment terminal and (ii) a second user selection, from the loaded set of virtual test card profiles, of a given virtual test card profile for use in testing the given payment terminal; and
based on the first and second user selections, selectively operating in either:
(i) a first operating mode in which the client device emulates a physical payment card in accordance with the given virtual test card profile; or
(ii) a second operating mode in which the client device configures a configurable payment card to operate in accordance with the given virtual test card profile.

18. The method of claim 17, wherein:
while selectively operating in the first operating mode, the client device logs test data related to a test transaction between the client device and the given payment terminal; and
while selectively operating in the second operating mode, the client device wirelessly retrieves, from the configurable payment card, test data related to a test transaction between the configurable payment card and the given payment terminal.

19. The method of claim 17, selectively operating in the first operating mode in which the client device emulates the physical payment card in accordance with the given virtual test card profile comprises:
engaging in wireless communications with the given payment terminal related to a test transaction between the client device and the given payment terminal.

20. The method of claim 17, wherein selectively operating in the second operating mode in which the client device configures the configurable payment card to operate in accordance with the given virtual test card profile comprises:
wirelessly transferring at least a portion of the given virtual test card profile to the configurable payment card.
